(19) United States
(12) Patent Application Publication
(10) Pub. No.: US 2009/0325573 A1
(43) Pub. Date: Dec. 31, 2009

(54) METHODS AND APPARATUS FOR ROAMING IN A WIRELESS NETWORK

(75) Inventors: David A. MEYER, East Meadow, NY (US); George T. DELLARATTA, JR., Shirley, NY (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 12/123,994

(22) Filed: May 20, 2008

(51) Int. Cl. H04W 4/00

(52) U.S. Cl. 455/432.1; 370/338

(57) ABSTRACT

Methods and systems are provided for improving network connectivity utilizing a roaming procedure in which the mobile units are able to associate with multiple access ports during roaming. The mobile unit, while connected to one access port, associates with a second access port. While maintaining the connection to the first access port, the mobile unit performs various initialization procedures, including exchange of encryption keys, authentication, DHCP renewal, and the like. After a connection is established with the second access port, the mobile unit disconnects from the first access port. Thus, during the roaming process, the MU is connected to two APs at the same time for a short length of time.

### TECHNICAL FIELD

The present invention relates to wireless local area networks (WLANs) and other networks incorporating RF elements and/or RF devices. More particularly, the present invention relates to methods for accommodating roaming of mobile units in a wireless network.

### BACKGROUND

There has been a dramatic increase in demand for mobile connectivity solutions utilizing various wireless components and WLANs. Such networks generally involve the use of wireless access points (APs) configured to communicate with mobile devices using one or more RF channels in accordance with various wireless standards and protocols.

When mobile devices move from region to region, they roam between available access points. There are many steps involved in disconnecting then reconnecting to the network during roaming, including, for example, authentication, encryption key exchange, IP address renewal, and the like. Such steps cause significant delays in network availability for the mobile device during the roaming event.

The significance of this roaming problem increases in contexts and environments where frequent roaming takes place, or where voice over IP (VOIP) is used. Prior attempts have focused, with limited success, on reducing the delay associated with each of these steps. Nevertheless, current roaming methods remain unsatisfactory in this respect.

Accordingly, there is a need for improved methods and systems for accommodating roaming of mobile units in wireless networks.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a wireless network useful in describing various embodiments of the present invention.

### DETAILED DESCRIPTION

The present invention relates to systems and methods for improving network connectivity utilizing a procedure in which the mobile units are able to associate with multiple access ports during roaming. In this regard, the following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components (e.g., APs, MUs, and switches) may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of data transmission and data formatting protocols and that the system described herein is merely one example embodiment of the invention.

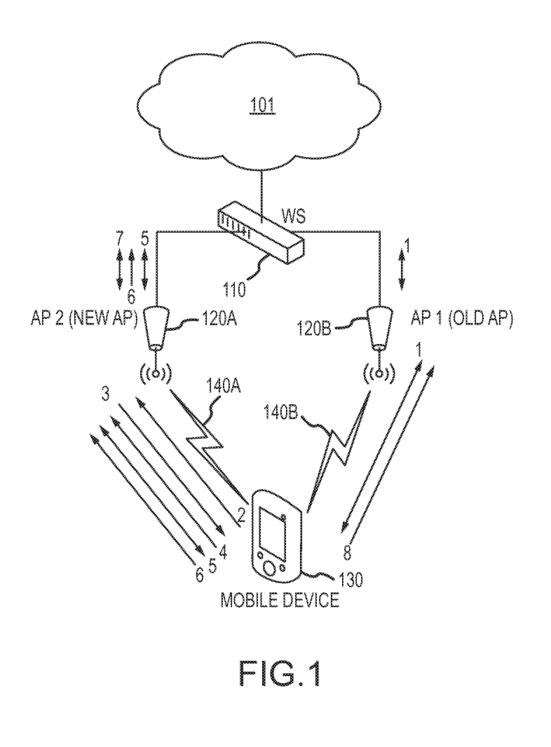

For the sake of brevity, conventional techniques related to wireless roaming, signal processing, data transmission, signaling, network control, the 802.11 family of specifications, wireless networks, and other functional aspects of the systems (and the individual operating components of the systems) may not be described in detail herein. Furthermore, the connecting lines shown in FIG. 1 contained herein are intended to represent example functional relationships and/or physical couplings between the various elements. It should be noted that many alternative or additional functional relationships or physical connections may be present in an embodiment of the invention.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example,” rather than “model.” Although the figures may depict example arrangements of elements, additional intervening elements, devices, features, or components may be present in an embodiment of the invention.

Referring to FIG. 1, in an example architecture useful in describing the present invention, a switching device 110 (alternatively referred to as an “RF switch,” “WS,” or simply “switch”) is coupled to a network 101 (e.g., an Ethernet network coupled to one or more other networks or devices) which generally communicates with one or more enterprise applications (not shown) and one or more wireless access ports 120 (alternatively referred to as “access ports” or “APs”).

APs 120 are configured to wirelessly associate with and connect to one or more mobile units 130 (or “MUs”), within an environment, which may be indoors and/or outdoors. It will be appreciated that a typical real-world environment may have many more such APs: two APs and one MU are depicted in this example solely for the purpose of clarity. The environment, which may correspond to a workplace, a retail store, a home, a warehouse, or any other such space, will typically include various physical features that affect the nature and/or strength of RF signals received and/or sent by the APs 120. These features include, for example, architectural structures such as doors, windows, partitions, walls, ceilings, floors, machinery, lighting fixtures, and the like.

APs 120 suitably communicate with switch 110 via appropriate communication lines—e.g., conventional Ethernet lines or the like. Each AP includes one or more antennas with an associated RF range (not illustrated) which depends upon, among other things, the strength of the respective antenna, and may be defined by a variety of shapes, depending upon the nature of the antenna. Furthermore, any number of additional and/or intervening switches, routers, servers and other network components may also be present in the system.

In general, WS 110 determines the destination of packets it receives and routes those packets to the appropriate AP 120 if the destination is an MU 130 with which the AP is associated. Each WS 110 therefore maintains a routing list of MUs 130 and their associated APs 120. These lists are generated using a suitable packet handling process as is known in the art. Thus, each AP 120 acts primarily as a conduit, sending/receiving RF transmissions via MUs 130, and sending/receiving packets via a network protocol with WS 110.

WS 110 may support any number wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB.

As described in further detail below, WS 110 includes hardware, software, and/or firmware capable of carrying out the functions described herein. Thus, switch 110 may comprise one or more processors accompanied by storage units, displays, input/output devices, an operating system, database management software, networking software, and the like. Such systems are well known in the art, and need not be described in detail. Switch 110 may be configured as a general purpose computer, a network switch, or any other such network host. In a preferred embodiment, controller or switch 102 is modeled on a network switch architecture but includes RF network controller software (or “module”) whose capabilities include, among other things, the ability to effect roaming as described herein.

WS 110 may include a cell controller (CC) and an RFID network controller (RNC) (not shown). The RNC includes hardware and software configured to handle RFID data communication and administration of the RFID network components, while the CC includes hardware and software configured to handle wireless data (e.g., in accordance with IEEE 802.11) from the mobile units and access ports within wireless cells. In one embodiment, WS 110 includes a single unit with an enclosure containing the various hardware and software components necessary to perform the various functions of the CC and RNC as well as suitable input/output hardware interfaces to any networks connected thereto.

Referring again to the example conceptual view shown in FIG. 1, in accordance with the present invention, when MU 130 roams between two APs 120A and 120B, MU 130 temporarily maintains a connection with both AP 120A and 120B (through wireless connections 140A and 140B). Stated another way, mobile unit 130 is, for a brief time, connected to both APs contemporaneously.

When the client (MU 130) determines that it is time to roam, it will begin to associate with a new AP 120, and upon successful association will not yet drop the connection to the previous AP. While both APs 120 are connected to MU 130, MU 130 will authenticate the new AP and complete any other network initialization needed (i.e., DHCP renewed to obtain an IP address) before dropping the previous connection. This allows the mobile device to ensure that a full connection is ready with the new access point before losing the previous connection. In contrast, convention pre-emptive roaming involves determining when to roam, but does not attempt to authenticate or obtain an IP address before switching to the new AP 120.

The procedural arrows labeled 1-8 in FIG. 1 depict the various steps and relevant components of a method in accordance with the present invention, and will now be described. Initially, in step 1, a connection is assumed to be already established between AP 120B and MU 130. Thus, all traffic from and to MU 130 travels through AP 120B and WS 110 through connection 140B in the conventional manner.

Next, in step 2, MU 130 determines that it will begin association with AP 120A, which is within range. This determination may be made in accordance with any suitable criterion. For example, MU 130 might discern that the signal strength to AP 120A is greater (or is increasing at a higher rate) than that associated with AP 120B.

Subsequently, in step 3, an association between MU 130 and AP 120A is deemed successful, and MU 130 can then begin connecting to the network (step 4). This might involve a number of steps known in the art, such as authentication, encryption key exchange, DHCP address renewal, and the like.

In step 5, all connection-related packets begin to be routed through AP 120A, and in step 6 WS 110 is informed that the connection between AP 120A and MU 130 is ready. At this point, in step 7, all packets may be routed through AP 120A, even though a connection through AP 120B still exists. Thus, in contrast with standard pre-emptive roaming, the present invention provides a procedure wherein the mobile unit is fully connected to two APs for a length of time. The duration of this dual-AP state will vary depending upon, among other things, the initialization process, as is known in the art.

MU 130 then disconnects from AP 120B, using AP 120A exclusively for wireless communication. The process outlined above may be repeated numerous times as MU 130 travels within the environment, roaming from one AP to another as required. As can be seen, this method prevents “dead time” where no connection is present, as is common with conventional pre-emptive roaming.

Both MU 130 and switch 110 are thus configured to perform the steps described above. The firmware and/or software within WS 110 is configured to recognize specialized information from the MU 130 and handles routing the MU's traffic to two different APs based on the type of traffic (i.e., initialization traffic through one path, and data traffic through the other). At the same time, the firmware and/or software within MU 130 is configured to handle switching between two APs (e.g., if they are on different channels, would need to switch the channel back and forth).

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A method for roaming within a wireless network, comprising the steps of:
providing a mobile unit in an environment;
providing a first access port configured to wirelessly communication with the mobile unit;
providing a second access port configured to wirelessly communicate with the mobile unit, wherein the second access port is physically remote from the first access port;
establishing a first connection between the first access port and the mobile unit such that all data communication from and to the mobile unit passes through the first access port; and
establishing an association between the mobile unit and the second access port while the first connection remains established.

2. The method of claim 1, further including establishing a second connection between the mobile unit and the second access port while the first connection remains established.

3. The method of claim 2, wherein, while the first connection remains established, the mobile unit and the second access port perform authentication.

4. The method of claim 2, wherein, while the first connection remains established, the mobile unit and the second access port exchange encryption key exchange.

5. The method of claim 2, wherein, while the first connection remains established, the mobile unit and the second access port perform DHCP address renewal.

6. The method of claim 2, further including disconnecting from the first connection a non-zero time after the second connection is established.

7. A roaming method for a mobile unit in which the mobile unit remains connected to a first access port while establishing a connection with a second access port.

8. The roaming method of claim 7, wherein the mobile unit is connected to the first access port and the second access port contemporaneously.

9. The roaming method of claim 7, wherein establishing the connection includes performing an authentication step.

10. The roaming method of claim 7, wherein establishing the connection includes performing an authentication step.

11. The roaming method of claim 7, wherein data communication related to initialization of the second access port passes through the second access port, and all other communication passes through the first access port.

12. A system for roaming within a network, comprising:
a mobile unit wirelessly connected to the network;
a first access port connected to the network; and
a second access port connected to the network;
wherein the mobile unit is configured to establish a connection with the first access port and to associate with the second access port while remaining connected to the first access port.

13. The system of claim 12, wherein the mobile unit established a connection with the second access port while remaining connected to the first access port.

14. The system of claim 12, wherein, while the mobile unit remains connected to the first access port, the mobile unit and the second access port at least one initialization procedure.

15. The system of claim 12, wherein the mobile unit is further configured to disconnect from the first access port after connecting to the second access port.
